(19) United States
(12) Patent Application Publication
(10) Pub. No.: US 2023/0073745 A1
(43) Pub. Date: Mar. 9, 2023

(54) DISASTER PREDICTION AND PROACTIVE MITIGATION

(71) Applicant: INTERNATIONAL BUSINESS MACHINES CORPORATION, ARMONK, NY (US)

(72) Inventors: Sarbajit K. Rakshit, Kolkata (IN); Partho Ghosh, Kolkata (IN); Saraswathi Sailaja Perumalla, Visakhapatnam (IN)

(21) Appl. No.: 17/447,103

(22) Filed: Sep. 8, 2021

(51) Int. Cl. G06N 5/04; G06N 5/02; G06Q 50/02; G06Q 40/08

(52) U.S. Cl. CPC G06N 5/04; G06N 5/022; G06Q 40/08; G06Q 50/02; G08B 7/00

(57) ABSTRACT

According to one embodiment, a method, computer system, and computer program product for disaster prediction and mitigation is provided. The embodiment may include generating a knowledge corpus of a grazing pattern of a livestock group in a preconfigured area. The embodiment may also include generating a knowledge corpus of a growing pattern of flora for each of a plurality of sections in the preconfigured area. The embodiment may further include generating a prediction based on the knowledge corpuses. The embodiment may also include performing an action based on the prediction.

### BACKGROUND

The present invention relates generally to the field of computing, and more particularly to the Internet of Things (IoT).

IoT relates to an interrelated system of objects that are capable of transferring data across a network without requiring human participation. Currently, many devices available in the consumer marketplace are equipped with “smart” capabilities which include the capability to connect to a network through wired or wireless connections. These devices include many items from smartphones and wearables to refrigerators, lightbulbs, and vehicles. Despite many known uses in the commercial sphere, IoT can also be utilized industrially to improve efficiency and reduce consumable resources. For example, implementing IoT technology throughout a city transportation or electrical grid may assist in reduction of traffic or inefficient energy usage.

### SUMMARY

According to one embodiment, a method, computer system, and computer program product for disaster prediction and mitigation is provided. The embodiment may include generating a knowledge corpus of a grazing pattern of a livestock group in a preconfigured area. The embodiment may also include generating a knowledge corpus of a growing pattern of flora for each of a plurality of sections in the preconfigured area. The embodiment may further include generating a prediction based on the knowledge corpuses. The embodiment may also include performing an action based on the prediction.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a disaster prediction and mitigation process according to at least one embodiment.

FIG. 3 is a block diagram of internal and external components of computers and servers depicted in FIG. 1 according to at least one embodiment.

FIG. 4 depicts a cloud computing environment according to an embodiment of the present invention.

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to the Internet of Things (IoT). The following described exemplary embodiments provide a system, method, and program product to, among other things, track and manipulate a livestock grazing pattern in order to prevent and mitigate risk of a natural disaster. Therefore, the present embodiment has the capacity to improve the technical field of IoT by reducing natural disaster risk through integration of IoT-enabled devices and sensors throughout a preconfigured area.

As previously described, IoT relates to an interrelated system of objects that are capable of transferring data across a network without requiring human participation. Currently, many devices available in the consumer marketplace are equipped with “smart” capabilities which include the capability to connect to a network through wired or wireless connections. These devices include many items from smartphones and wearables to refrigerators, lightbulbs, and vehicles. Despite many known uses in the commercial sphere, IoT can also be utilized industrially to improve efficiency and reduce consumable resources. For example, implementing IoT technology throughout a city transportation or electrical grid may assist in reduction of traffic or inefficient energy usage.

IoT technology may also have beneficial implementation throughout industrial farming areas, such as livestock management. In forested, mountainous, or grassland environments, grazing livestock may freely roam. In such areas, there may be an increased risk of natural disasters, such as wildfires and landslides, due to a delicate balance between the natural landscape and the livestock’s necessary food and water consumption. For example, if grasses, brush, and other shrubbery become overgrown due livestock favoring other landscape areas, the risk of a quickly spreading brushfire, for example, due to a nearby lighting strike, may result. Similarly, overgrazing by livestock may result in a barren landscape devoid of natural flora and susceptible to landslides in the event of excessive rains. The risk of natural disasters such as these is made even more significant due to the increasing frequency of extreme weather events, such as droughts, hurricanes, severe thunderstorms, and heat waves, caused by climate change. As such, it may be advantageous to, among other things, utilize IoT technology to monitor and influence the grazing patterns of livestock so as to predict and mitigate the risk of natural disasters over a preconfigured area.

According to at least one embodiment, IoT sensors may monitor the grazing pattern of livestock in a preconfigured area, such as a grazing pasture, to determine areas of the preconfigured area that the livestock favor or disfavor. When a particular segment of the preconfigured area is determined to be at an increased risk for a natural disaster, such as a wildfire or a landslide, due to the growing pattern of the flora in the segment, IoT devices, such as robotic shepherding devices, may be implemented to herd the livestock away from or toward the segment of that is at an increased natural disaster risk.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to identify areas of a preconfigured area at an increased risk for the occurrence of a natural disaster and shepherd livestock around the preconfigured area in order to prevent or mitigate the increased risk.

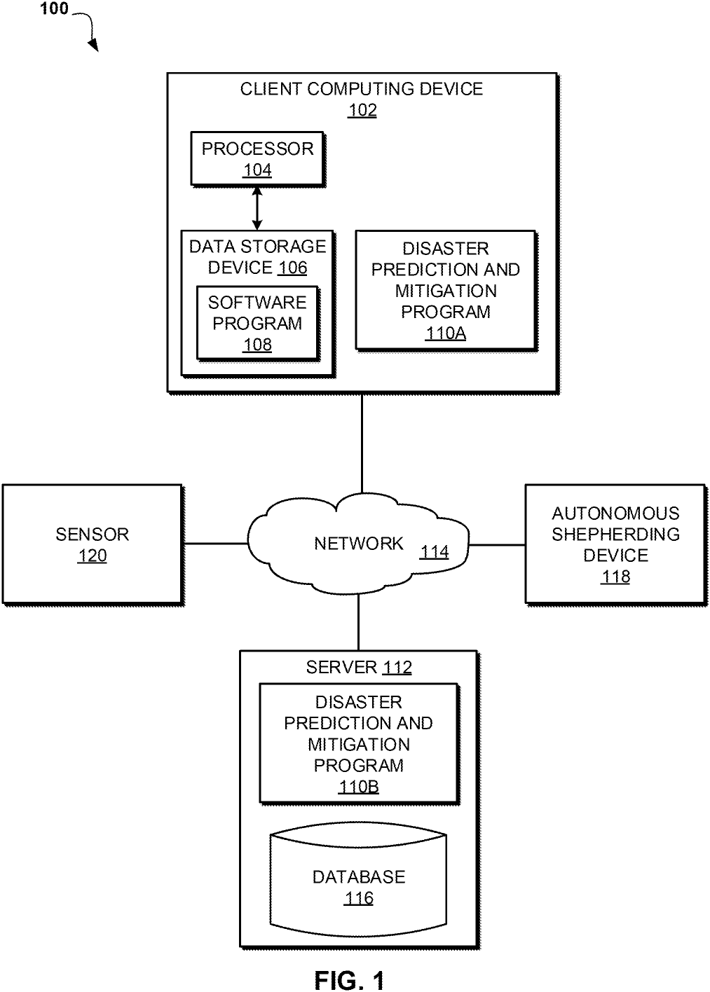

Referring to FIG. 1, an exemplary networked computer environment 100 is depicted, according to at least one embodiment. The networked computer environment 100 may include client computing device 102, a server 112, one or more autonomous shepherding devices 118, and one or more sensors 120 interconnected via a communication network 114. According to at least one implementation, the networked computer environment 100 may include a plurality of client computing devices 102, servers 112, autonomous shepherding devices 118 and sensors 120, of which only one of each is shown for illustrative brevity. Additionally, in one or more embodiments, the client computing device 102 and server 112 may each individually host a disaster prediction and mitigation program 110A, 110B. In one or more other embodiments, the disaster prediction and mitigation program 110A, 110B may be partially hosted on both the client computing device 102 and the server 112 so that functionality may be separated between the devices.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

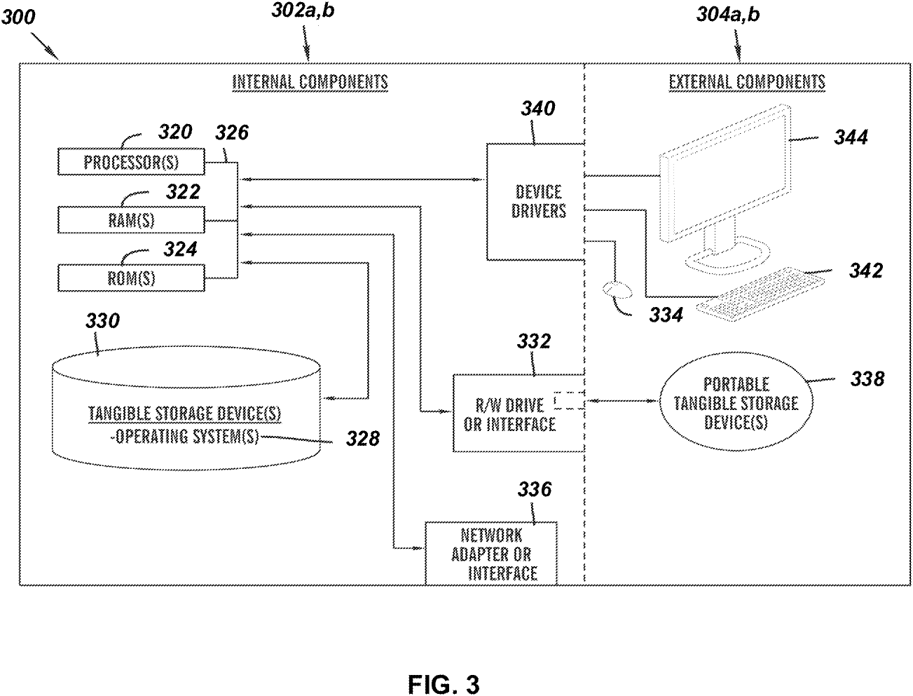

Client computing device 102 may include a processor 104 and a data storage device 106 that is enabled to host and run a software program 108 and a disaster prediction and mitigation program 110A, receive data from one or more sensors, such as sensor 120, transmit instructions to the autonomous shepherding device 118, and communicate with the server 112 via the communication network 114, in accordance with one embodiment of the invention. In one or more other embodiments, client computing device 102 may be, for example, a mobile device, a telephone, a personal digital assistant, a netbook, a laptop computer, a tablet computer, a desktop computer, or any type of computing device capable of running a program and accessing a network. As previously described, one client computing device 102 is depicted in FIG. 1 for illustrative purposes, however, any number of client computing devices 102 may be utilized. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a disaster prediction and mitigation program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

According to the present embodiment, sensor 120 may include location tracking devices capable of identifying the location of one or more members in a herd of livestock. Sensor 120 may include a global positioning system (GPS) device, a Bluetooth-enabled device, Wifi-enabled device, a cellular communication device, or any other location tracking device capable of being affixed to (e.g., an ear tag or collar-like device) or embedded within (e.g., microchipping) livestock. In at least one embodiment, the sensor 120 may be capable of transmitting captured location tracking information to the client computing device 102 and the server 112 via communication network 114. A single sensor 120 is depicted in FIG. 1 for illustrative purposes, however, any number of sensors 120 may be utilized.

According to the present embodiment, one or more sensors 120, which may be separate entities from the location tracking devices previously described, may also be capable of image capture capabilities, such as a video capture. When representing a video capture device (e.g., a camera), the one or more sensors 120 may be affixed to stationary objects, such as a fence post or tree, within or nearby an enclosure within which the livestock reside and capable of capturing images of the livestock. In at least one embodiment, the sensor 120 may be capable of changing the angle and position at which images are captured. Furthermore, the sensor 120 may also be capable of capturing micromovements of each member of a group of livestock to which the sensor 120 is affixed, such as capable by an accelerometer or a gyroscope. In at least one embodiment, the sensor 120 may be capable of transmitting captured images or videos to the client computing device 102 and the server 112 via communication network 114.

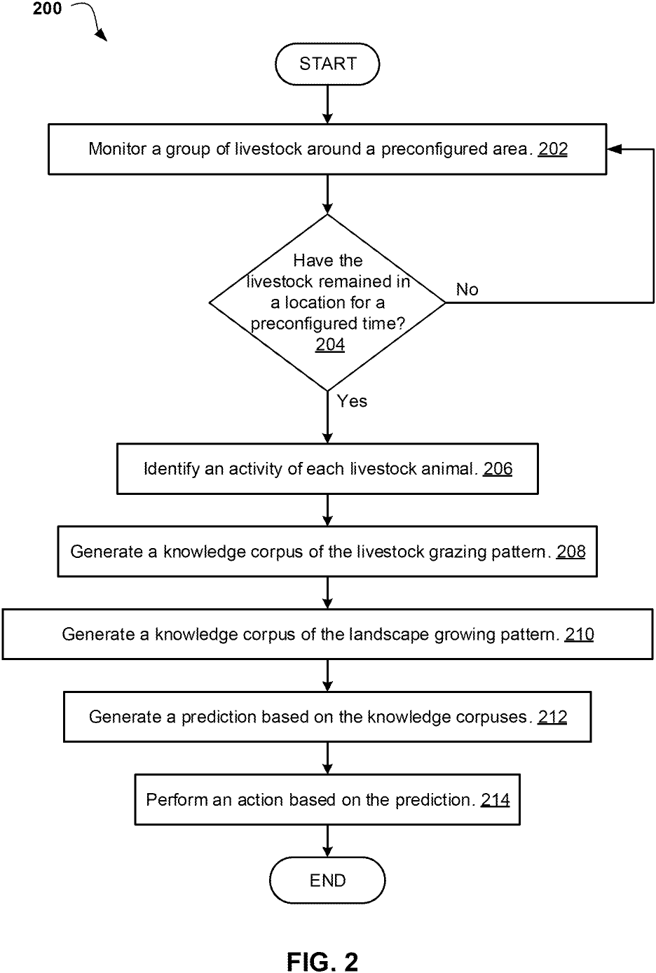

According to the present embodiment, the autonomous shepherding device 118 may include any robotic device capable of autonomous or remotely-controlled shepherding of livestock. For example, the autonomous shepherding device 118 may be a drone device or a dynamic highly-mobile robotic device. The autonomous shepherding device 118 may be capable of communicating with client computing device 102 and server 120 via communication network 114 to receive livestock location data and shepherding instructions. In at least one embodiment, the autonomous shepherding device 118 may be capable of capturing and transmitting a video feed or still images of the activities of each livestock animal to the client computing device 102 or server 112 that may then be used by the disaster prediction and mitigation program 110A, 110B described below and in any of the method steps in FIG. 2.

According to the present embodiment, the disaster prediction and mitigation program 110A, 110B may be capable of monitoring a grazing pattern of a group of livestock through analysis of received location data and image data from one or more sensors, such as sensor 120. The disaster prediction and mitigation program 110A, 110B may also be capable of determining whether risk of a natural disaster to a preconfigured area is elevated based on the captured image data and the grazing pattern. In the event the risk is elevated, the disaster prediction and mitigation program 110A, 110B may utilize a shepherding device, such as autonomous shepherding device 118, to move the livestock away from or toward a specific segment of the preconfigured area according to the specific determined risk. The disaster prediction and mitigation method is explained in further detail below with respect to FIG. 2.

Referring now to FIG. 2, an operational flowchart illustrating a disaster prediction and mitigation process 200 is depicted according to at least one embodiment. At 202, the disaster prediction and mitigation program 110A, 110B monitors a group of livestock around a preconfigured area. By definition, the group of livestock may include more than one herbivorous animal and, as naturally occurs, each animal in the group may be present in various locations around a pasture, field, or other grazing area. In order to monitor the location and behavior of each member of the group, a location tracking sensor, such as sensor 120, may be affixed to one or more members of the group of livestock. For example, each location tracking sensor may be affixed, such as an ear tag or a collar, or embedded under skin, such as a microchip. Each sensor 120 may transmit real-time location data of each member of the group of livestock to the client computing device 102 or the server 112 via network 114. In at least one embodiment, the disaster prediction and mitigation program 110A, 110B may uniquely identify each member of the group of livestock so as to monitor the movements and activity of each member separately from each other member.

In at least one embodiment, the sensor 120 may be one or more video capture devices capable of identifying livestock through image recognition technology and transmitting the presence of the livestock near the sensor 120 to the client computing device 102 or the server 112 via network 114. In such an example, the livestock location may be tracked without location tracking sensors being affixed or embedded as described above.

Then, at 204, the disaster prediction and mitigation program 110A, 110B determines whether the livestock remained in a location for a preconfigured time. Using the location data captured from the sensor 120, the disaster prediction and mitigation program 110A, 110B may determine whether the livestock being tracked have remained in a specific location for a preconfigured time. As such, the disaster prediction and mitigation program 110A, 110B may be capable of identifying whether the group of livestock have overgrazed a specific segment of the preconfigured area. In at least one embodiment, a determination that the group of livestock has remained in the preconfigured area for the preconfigured period of time may also indicate to the disaster prediction and mitigation program 110A, 110B that one or more other sections of the preconfigured area are under-grazed and/or overgrown and may be in need of grazing by the group of livestock in order to reduce an risk of occurrence of a natural disaster. If the disaster prediction and mitigation program 110A, 110B determines the livestock have remained in the location for a preconfigured period of time (step 204, “Yes” branch), then the disaster prediction and mitigation process 200 may proceed to step 206 to identify an activity of each livestock animal. If the disaster prediction and mitigation program 110A, 110B determines the livestock have not remained in the location for the preconfigured period of time (step 204, “No” branch), then the disaster prediction and mitigation process 200 may return to step 202 to monitor the group of livestock in the preconfigured area.

Then, at 206, the disaster prediction and mitigation program 110A, 110B identifies an activity of each livestock animal. Using various feature capabilities of sensors 120, the disaster prediction and mitigation program 110A, 110B may identify the current activities of the group of livestock. Identification of the current activities is necessary for the disaster prediction and mitigation program 110A, 110B to determine if the current location of the group of livestock or each individual member has been overgrazed. For example, using an embedded gyroscope and/or accelerometer in a sensor 120 affixed as an ear tag, the disaster prediction and mitigation program 110A, 110B may be capable of determining that a member of the group of livestock is eating due to regular and consistent head movements. Similarly, through image recognition of a video feed, the disaster prediction and mitigation program 110A, 110B may be capable of determining that a group of livestock are sleeping. In at least one embodiment, the autonomous shepherding device 118 may be capable of capturing and transmitting a video feed or still images of the activities of each livestock animal to the client computing device 102 or server 112.

Next, at 208, the disaster prediction and mitigation program 110A, 110B generates a knowledge corpus of the livestock grazing pattern. Through collection of the identified activities around the preconfigured area, the disaster prediction and mitigation program 110A, 110B may generate a knowledge corpus that tracks the grazing pattern of the group of livestock. The grazing pattern may be calculated using the location of each member of the group of livestock, the length of time each member of the group of livestock remained in a specific location, and the activity each member of the group of livestock engaged in while present at a specific location in the preconfigured area. Furthermore, the disaster prediction and mitigation program 110A, 110B may be capable of determining an average grazing rate for each member of the group of livestock based on the species of the member. For example, a cow may graze at a different rate than a sheep. Since a group of livestock may consist of a variety of species, the disaster prediction and mitigation program 110A, 110B may identify a grazing rate for each member of the group of livestock.

Then, at 210, the disaster prediction and mitigation program 110A, 110B generates a knowledge corpus of the landscape growing pattern. Each pasture containing a group of livestock may have a different growing rate based on the flora growing within the preconfigured area. For example, a quackgrass may grow at a different rate that an annual ryegrass depending on environmental conditions. The disaster prediction and mitigation program 110A, 110B may generate the knowledge corpus to identify a growing pattern of one or more sections of the preconfigured area in order to determine a frequency and amount of grazing necessary by the group of livestock to maintain the preconfigured area and reduce or eliminate any natural disaster risk presented by overgrazing or overgrowth. The disaster prediction and mitigation program 110A, 110B may identify each flora type through image recognition of a video feed, or images captured, by one or more image capture devices, such as sensor 120. In at least one other embodiment, manual user input of flora type and location of each flora type may be implemented. The disaster prediction and mitigation program 110A, 110B may be capable of identifying the growing rates, soil requirements, water requirements, root depth, flammability, and other characteristics of various flora types through user preconfiguration or through a database search, such as utilizing an internet-based search engine. Furthermore, the disaster prediction and mitigation program 110A, 110B may consider the landscape characteristics, such as soil characteristics, terrain characteristics, plant coverage, tree coverage, etc. when generating the knowledge corpus.

When generating the knowledge corpus, the disaster prediction and mitigation program 110A, 110B may also consider recent weather conditions that may affect, even temporarily, the growing pattern. For example, if an inch of rain was received in the previous 24 hours, the disaster prediction and mitigation program 110A, 110B may determine that the growing pattern of the preconfigured area may be increased for the next two or three days until wet conditions subside. Similarly, the disaster prediction and mitigation program 110A, 110B may consider recent weather characteristics when determining whether flora within the preconfigured area are presently more susceptible to a natural disaster. For example, flora that received rain recently may be less likely to foster and spread a wildfire than flora that is currently experiencing a drought.

Next, at 212, the disaster prediction and mitigation program 110A, 110B generates a prediction based on the knowledge corpuses. The disaster prediction and mitigation program 110A, 110B may make a prediction as to the status of the flora of sections of the preconfigured area using the knowledge corpuses. For example, the disaster prediction and mitigation program 110A, 110B may determine that a specific section of the preconfigured area has not been frequented by the group of livestock in some time and, due to overgrowth as estimated by a calculated growth pattern in that section, the specific section may be at an elevated risk for a wildfire and should be grazed by the livestock to reduce the elevated risk. Similarly, the disaster prediction and mitigation program 110A, 110B may determine that the current location of a group of livestock has been overgrazed due to the group’s extended presence in that location and should be moved to a less grazed area so as to reduce an increased risk of a landslide in the event of increased rainfall. In this sense, the disaster prediction and mitigation program 110A, 110B may identify a location as to where the group of livestock should be shepherded by a shepherding device, such as the autonomous shepherding device 118, when making the prediction.

Then, at 214, the disaster prediction and mitigation program 110A, 110B performs an action based on the prediction. The disaster prediction and mitigation program 110A, 110B may perform a variety of actions based on the determination that the group of livestock should be relocated to a different segment of the preconfigured area. In at least one embodiment, the disaster prediction and mitigation program 110A, 110B may utilize an autonomous device, such as autonomous shepherding device 118, to direct the group of livestock from one location to another based on the location identified in the prediction. The autonomous device may shepherd the livestock using one or more shepherding methods, such as recorded audio cues or haptic sensations. For example, the disaster prediction and mitigation program 110A, 110B may use one or more autonomous shepherding devices 118 to play a prerecorded cue of a dog while the one or more autonomous shepherding devices 118 maneuver around the group of livestock in order to direct the group to a location identified in the prediction. Similarly, the haptic sensations utilized by the disaster prediction and mitigation program 110A, 110B may relate to causing tactile sensations to be felt on the skin of one or more animals in the group of livestock through focused pressure fields created in mid-air by an array of ultrasound transducers. The autonomous device may produce the pressure fields through hosted technology and focus created waves towards one or more members of the group of livestock. In at least one other embodiment, the disaster prediction and mitigation program 110A, 110B may utilize a plurality of sound cue devices installed around a preconfigured area to direct the group of livestock to the location identified in the prediction. For example, the disaster prediction and mitigation program 110A, 110B may play a sound cue on one or more speakers affixed to poles or rods around the enclosed area that may provoke the livestock to move away from the speaker and toward the location identified in the prediction.

It may be appreciated that FIG. 2 provides only an illustration of one implementation and does not imply any limitations with regard to how different embodiments may be implemented. Many modifications to the depicted environments may be made based on design and implementation requirements. In at least one embodiment, any information captured by the sensor 120 and/or the autonomous shepherding device 118 as described above (e.g., a video feed, still images, location data, etc.) may also be utilized to monitor a status of the livestock. For example, the information captured by the sensor 120 and/or the autonomous shepherding device 118 may be utilized to identify when one or more members of the group of livestock are ill, dehydrated, or otherwise in need of attention. When such a determination is made, the action performed by the disaster prediction and mitigation program 110A, 110B in step 214 may include notifying a user (e.g., in the situation when an animal is identified as ill, in danger, or otherwise in need of individual attention) or shepherding the group of livestock to a location of need for the group (e.g., directing the group of livestock to water)

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the disaster prediction and mitigation program 110A in the client computing device 102 and the disaster prediction and mitigation program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the disaster prediction and mitigation program 110A, 110B, can be stored on one or more of the respective portable computer-readable tangible storage devices 338, read via the respective R/W drive or interface 332, and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 and the disaster prediction and mitigation program 110A in the client computing device 102 and the disaster prediction and mitigation program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the disaster prediction and mitigation program 110A in the client computing device 102 and the disaster prediction and mitigation program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service’s provider.
Broad network access: capabilities are available over a network and accessed through standard mechanisms that promote use by heterogeneous thin or thick client platforms (e.g., mobile phones, laptops, and PDAs).
Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

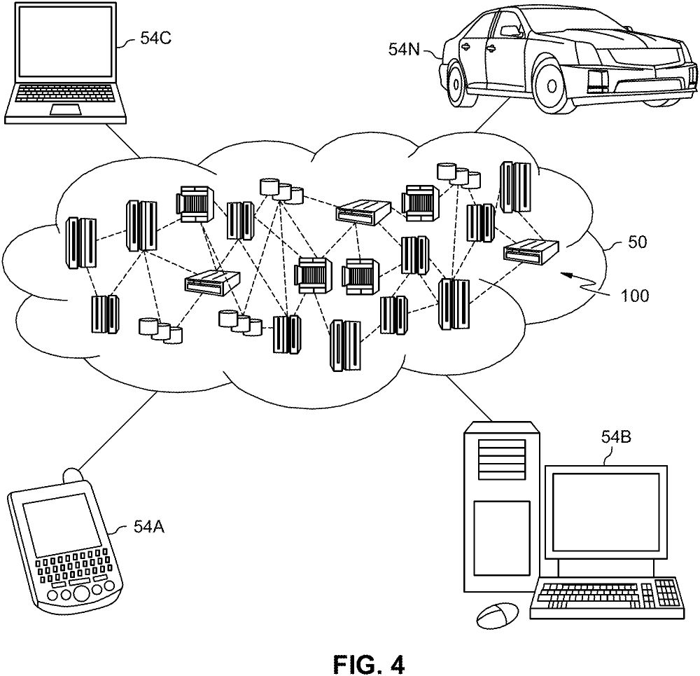

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

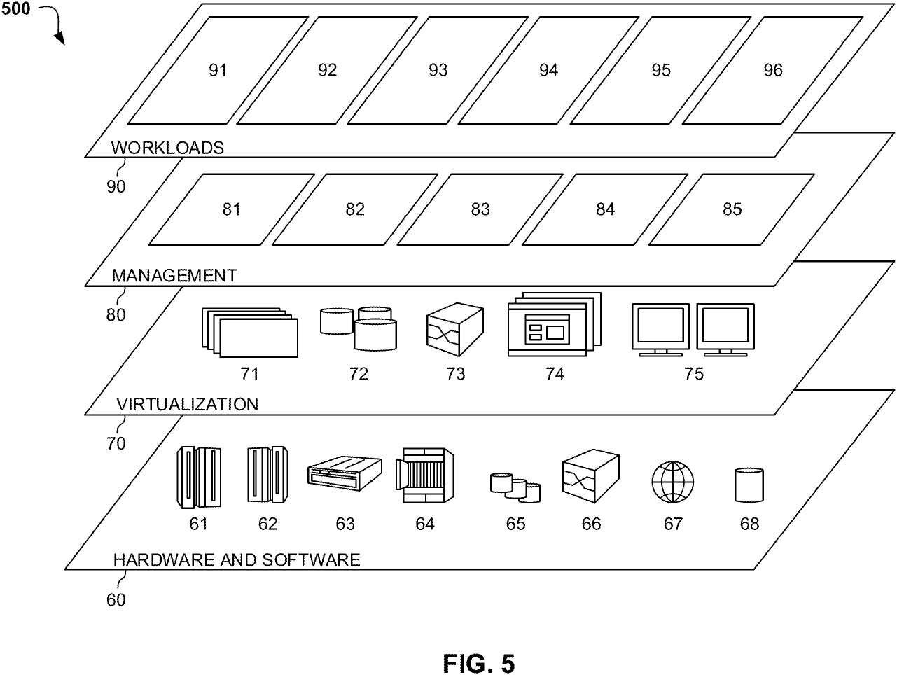

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and disaster prediction and mitigation 96. Disaster prediction and mitigation 96 may relate monitoring a grazing pattern of a group of livestock and shepherding the livestock to identified portions of a preconfigured area to prevent and/or mitigate the occurrence risk of a natural disaster.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
generating a knowledge corpus of a grazing pattern of a livestock group in a preconfigured area;
generating a knowledge corpus of a growing pattern of flora for each of a plurality of sections in the preconfigured area;
generating a prediction based on the knowledge corpuses; and
performing an action based on the prediction.

2. The method of claim 1, wherein the grazing pattern is determined by identifying an activity of each animal in the livestock group when the livestock group has remained in a location for a preconfigured period of time.

3. The method of claim 2, wherein the activity of each animal is identified using a plurality of sensors affixed to each animal or nearby the livestock group.

4. The method of claim 1, wherein the action comprises using an autonomous shepherding device to direct livestock group to a location identified in the generated prediction.

5. The method of claim 4, wherein the autonomous shepherding device directs the livestock group to the location using prerecorded audio cues and haptic sensations.

6. The method of claim 1, wherein the prediction comprises identifying an elevated risk of a natural disaster is present in a section of the preconfigured area and a location towards which the livestock group is to be directed so as to prevent or mitigate the elevated risk.

7. The method of claim 1, wherein the growing pattern comprises flora growing rates, soil requirements, flora water requirements, and recent weather conditions for each section.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating a knowledge corpus of a grazing pattern of a livestock group in a preconfigured area;
generating a knowledge corpus of a growing pattern of flora for each of a plurality of sections in the preconfigured area;
generating a prediction based on the knowledge corpuses; and
performing an action based on the prediction.

9. The computer system of claim 8, wherein the grazing pattern is determined by identifying an activity of each animal in the livestock group when the livestock group has remained in a location for a preconfigured period of time.

10. The computer system of claim 9, wherein the activity of each animal is identified using a plurality of sensors affixed to each animal or nearby the livestock group.

11. The computer system of claim 8, wherein the action comprises using an autonomous shepherding device to direct livestock group to a location identified in the generated prediction.

12. The computer system of claim 11, wherein the autonomous shepherding device directs the livestock group to the location using prerecorded audio cues and haptic sensations.

13. The computer system of claim 8, wherein the prediction comprises identifying an elevated risk of a natural disaster is present in a section of the preconfigured area and a location towards which the livestock group is to be directed so as to prevent or mitigate the elevated risk.

14. The computer system of claim 8, wherein the growing pattern comprises flora growing rates, soil requirements, flora water requirements, and recent weather conditions for each section.

15. A computer program product, the computer program product comprising:
one or more computer-readable tangible storage medium and program instructions stored on at least one of the one or more tangible storage medium, the program instructions executable by a processor capable of performing a method, the method comprising:
generating a knowledge corpus of a grazing pattern of a livestock group in a preconfigured area;
generating a knowledge corpus of a growing pattern of flora for each of a plurality of sections in the preconfigured area;
generating a prediction based on the knowledge corpuses; and
performing an action based on the prediction.

16. The computer program product of claim 15, wherein the grazing pattern is determined by identifying an activity of each animal in the livestock group when the livestock group has remained in a location for a preconfigured period of time.

17. The computer program product of claim 16, wherein the activity of each animal is identified using a plurality of sensors affixed to each animal or nearby the livestock group.

18. The computer program product of claim 15, wherein the action comprises using an autonomous shepherding device to direct livestock group to a location identified in the generated prediction.

19. The computer program product of claim 18, wherein the autonomous shepherding device directs the livestock group to the location using prerecorded audio cues and haptic sensations.

20. The computer program product of claim 15, wherein the prediction comprises identifying an elevated risk of a natural disaster is present in a section of the preconfigured area and a location towards which the livestock group is to be directed so as to prevent or mitigate the elevated risk.
